(19) United States
(12) Patent Application Publication
(10) Pub. No.: US 2008/0277951 A1
(43) Pub. Date: Nov. 13, 2008

(54) Motor Vehicle Front Part

(75) Inventors: Klaus Rathje, Hildrizhausen (DE); Dennis Waldherr, Heimsheim (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/911,585

(22) PCT Filed: Apr. 11, 2006
(86) PCT No.: PCT/EP2006/003307

§ 371 Date: Jun. 17, 2008

(30) Foreign Application Priority Data
Apr. 16, 2005 (DE) 10 2005 017 567.8

(51) Int. Cl. B60R 19/24; B60R 19/52; B60R 21/34

(52) U.S. Cl. 293/115; 293/155; 293/117

(57) ABSTRACT

A motor vehicle front part includes a bumper unit provided with a bumper crossmember and a support which rigidifies the bumper unit in a region upstream of the bumper crossmember upon impact with a pedestrian. The front part of a vehicle is provided with a bumper unit so that the pedestrian's protection is also improved on vehicles whose design do not enable a lower support to be incorporated. The support is therefore arranged above the bumper crossmember.

The invention relates to a motor vehicle front part with a bumper unit according to the preamble of claim 1.

The front parts of modern motor vehicles, in particular automobiles, are designed in such a way as to comply at least with the legally prescribed provisions with regard to a pedestrian impact. To this end, a series of tests are performed in order to investigate the behavior of vehicles in the event of accidents involving children or adults.

A support is known for a motor vehicle front part which stiffens the bumper unit in the event of a pedestrian impact in a lower region upstream of the bumper crossbar. This support has become known in specialist circles as a “lower stiffener”. Such a support prevents a pedestrian's lower leg from being pulled under the vehicle. At the same time, the pedestrian is given the impetus to roll purposefully over the hood.

However, there are motor vehicles whose structure prevents the provision of a lower support. For instance, vehicles in which an elevated slope angle is desired, for example SUVs, cannot be fitted with a lower support, since it would reduce the slope angle. The slope angle is generally understood by a person skilled in the art to be the angle formed between the carriageway at the level of the middle of the front wheel and the lower edge of the bumper unit. In SUVs the slope angle is generally greater than 25°.

The object of the invention consists in further developing a motor vehicle front part with a bumper unit in such a way that pedestrian protection is improved even in vehicles whose structure prevents the provision of a lower support.

The object is achieved according to the invention with the features of claim 1.

A motor vehicle front part is provided with a bumper unit comprising a bumper crossbar. Provision is made according to the invention for the support upstream of the bumper crossbar to be constructed above the bumper crossbar. This upper support prevents excessive twisting of the thigh under the hood, such that the bend angle between thigh and lower leg can be kept small. In this way, in the event of a pedestrian impact early support of the thigh is achieved. In the event of a pedestrian impact, which is simulated using a leg impactor, the leg impactor comes into contact firstly with an energy absorption element upstream of the bumper crossbar, in order that, in continuation, further twisting of the thigh is prevented by the upper support. The upper support provides a second load path, which is located substantially above the bumper unit. To ensure early upper support, existing components, such as for example the radiator cross member or the anti-collision radar mount, may be extended forwards. Alternatively, additional elements may be provided, which are supported on supporting structures or on the hood of the motor vehicle front part.

Advantageous developments of the invention are illustrated below with reference to the drawings, in which:

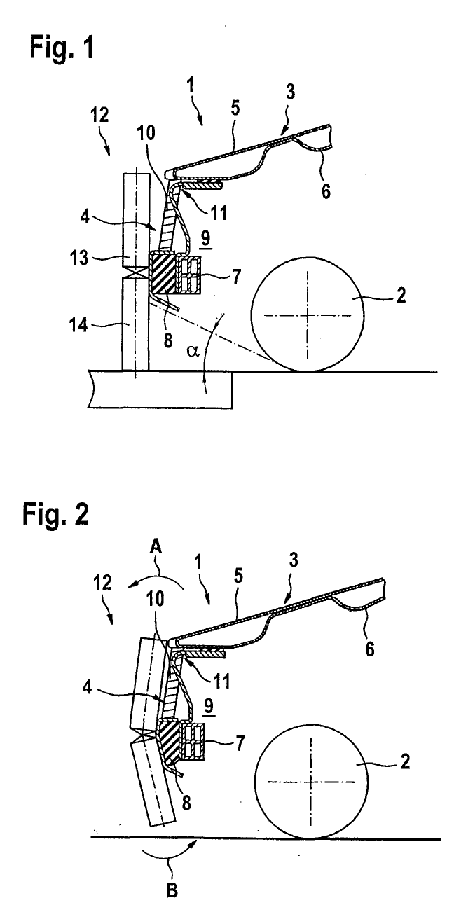

FIG. 1 is a schematic representation of a longitudinal section through a motor vehicle front part with an upper support,

FIG. 2 shows a longitudinal section according to FIG. 1 as a pedestrian impact proceeds further,

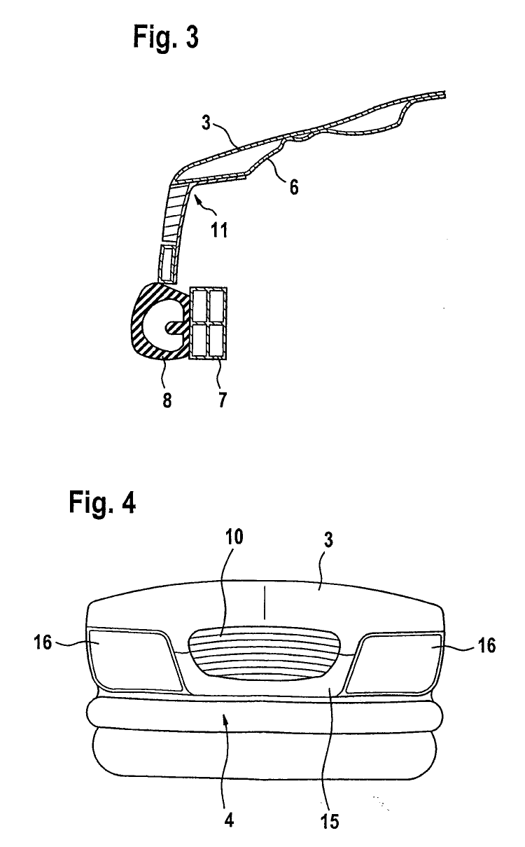

FIG. 3 is a schematic representation of a longitudinal section through a motor vehicle front part with a radiator grille fixed to the hood,

FIG. 4 shows a schematic front view of a motor vehicle front part with a radiator grille fixed to the hood as in FIG. 3,

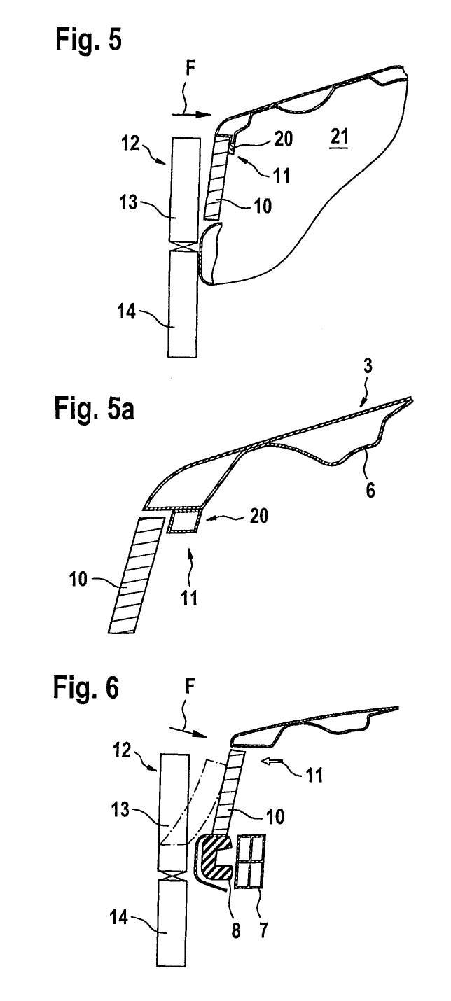

FIG. 5 is a schematic representation of a longitudinal section through a motor vehicle front part with a radiator grille fixed to the hood and a first embodiment of a support,

FIG. 6 is a schematic representation of a longitudinal section through a motor vehicle front part with a radiator grille fixed to the bumper,

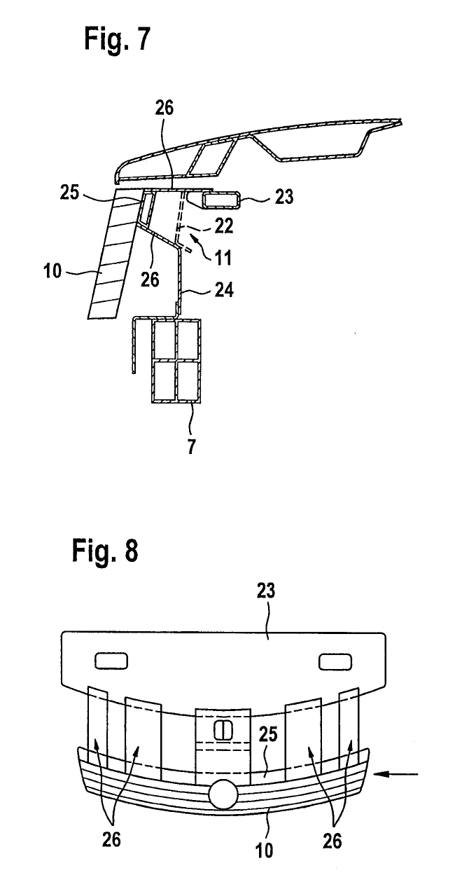

FIG. 7 is a schematic representation of a longitudinal section through a motor vehicle front part with a radiator grille fixed to the bumper and a second embodiment of a support,

FIG. 8 is a schematic plan view of the motor vehicle front part according to FIG. 7,

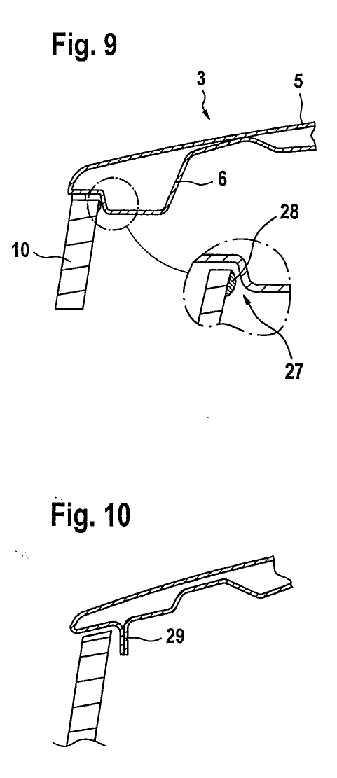

FIG. 9 is a schematic representation of a longitudinal section through a motor vehicle front part with a radiator grille fixed to the bumper and a third embodiment of a support,

FIG. 10 is a schematic representation of a longitudinal section through a motor vehicle front part with a radiator grille fixed to the bumper and a fourth embodiment of a support,

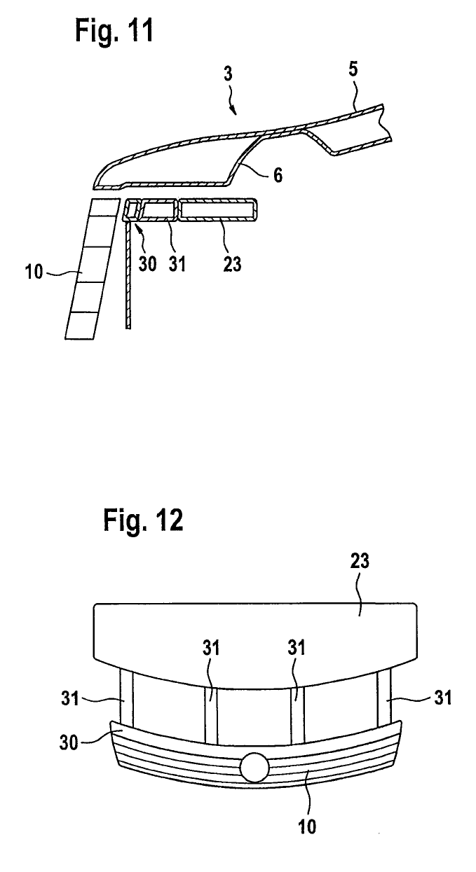

FIG. 11 is a schematic representation of a longitudinal section through a motor vehicle front part with a radiator grille fixed to the bumper and a fifth embodiment of a support,

FIG. 12 is a schematic plan view of the motor vehicle front part according to FIG. 11,

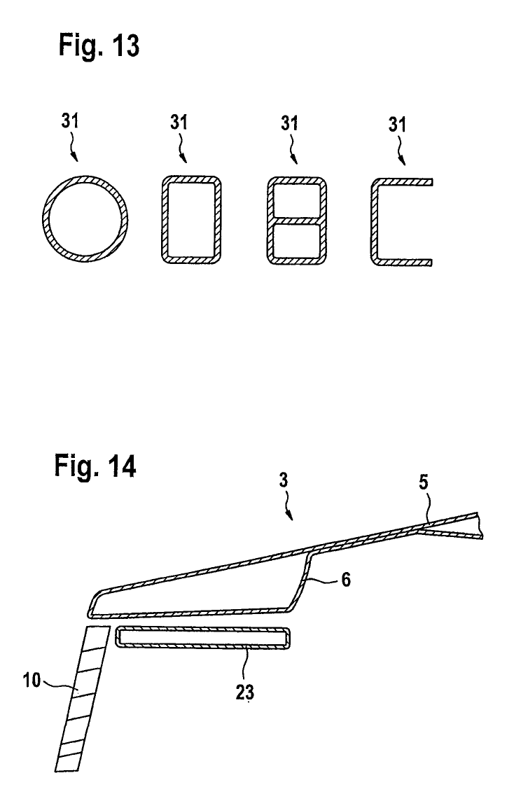

FIG. 13 shows profile cross sections of the additional element 30 according to FIG. 11 and

FIG. 14 is a schematic representation of a longitudinal section through a motor vehicle front part with a radiator grille fixed to the bumper and a sixth embodiment of a support.

FIGS. 1 and 2 are schematic representations of a longitudinal section through a motor vehicle front part 1 with front wheels 2. The motor vehicle front part 1 is delimited at the top by a hood 3 and at the front by a bumper unit 4.

The hood 3 comprises an outer skin 5 and a stiffening inner part 6.

The bumper unit 4 comprises a bumper crossbar 7, upstream of which there is arranged an absorption element 8. Above the bumper crossbar 7 there is arranged an air inlet opening 9, which is covered by a radiator grille 10.

The radiator grille 10 may be mounted either fixed to the hood or fixed to the bumper. A radiator grille fixed to the hood is understood to mean a radiator grille which is incorporated into the hood, such that the radiator grille is also moved when the hood is opened. A radiator grille fixed to the bumper is understood to mean a radiator grille which is attached to the bumper unit such that the radiator grille retains its fixed position when the hood is opened.

Irrespective of the manner of attaching the radiator grille 10 to the hood or to the bumper unit, a support 11 is provided in an upper region of the radiator grille 10, which stiffens the bumper unit 4 in the event of a pedestrian impact in a region upstream of the bumper crossbar 7.

This stiffening support 11 is supported in a manner described in greater detail below on a supporting structure of the motor vehicle front part 1.

FIG. 1 shows a leg impactor 12 with a thigh 13 and a lower leg 14 in a position which corresponds to first contact between the motor vehicle front part 1 and a potential accident victim. The motor vehicle front part 1 comes into contact with the leg impactor 12 first of all at the level of the absorption element 8. As FIG. 2 shows, as the impact proceeds contact arises between the thigh 13 and the upper support 11, such that the thigh 13 is deflected in the direction of travel in accordance with arrow A, while the lower leg 14 is given the impetus to move in the direction of arrow B. These opposing movements of thigh and lower leg result in minimization of the bend angle α formed between the thigh and the lower leg.

The following figures show various options for providing a support according to the invention for a motor vehicle front part, depending on the method of attaching the radiator grille.

FIGS. 3 and 4 show the principle of a radiator grille 10 fixed to the hood, as either a complete or partial component of the hood. In the case of a fully incorporated radiator grille 10, the hood 3 is extended by a frame 15 in the direction of the bumper unit. Light units 16 are positioned to the right and left of the region extended by the frame 15.

FIG. 5 shows a radiator grille 10 fixed to the hood, which grille 10 is secured against swiveling in the direction of the engine compartment 21 on exposure to a force F by means of a stop 20, which projects downwards from the inside 6 of the hood 3. Together with the radiator grille 10, this stop forms the support 11 and thus a second load path leading into the supporting structure of the motor vehicle front part 1. Alternatively, as FIG. 5a shows, the stop 2a may take the form of an additional part attached to the inside 6 of the hood 3. The additional part may here be made from metal or plastics.

FIG. 6 shows the principle of a radiator grille 10 fixed to the bumper, which grille 10 may either be attached directly to the bumper unit 4 or alternatively also to other supporting structures of the motor vehicle front part 1. This manner of attachment is conventional and does not therefore need to be explained in greater detail.

The support 11, here merely indicated by an arrow, is arranged above the bumper crossbar 7 as with radiator grilles fixed to the hood. The force acting via the leg impactor 12 is shown by arrow F.

The second embodiment of the support 11 shown in FIG. 7 is formed by a forwards extension of a conventional anti-collision radar mount 22, shown in part by broken lines.

The anti-collision radar mount 22 is of angular construction and is attached by its upper branch 23 to a radiator cross member 23 and by its lower branch 24 to the bumper crossbar 7. The radiator cross member 23 accommodates cooling units, not described in any further detail. The support 11 takes the form of an additional part and extends with a cross strut 25 over virtually the entire width of the vehicle. Brackets 26 project from the cross strut 25, these being attached to the anti-collision radar mount 22 or directly to the radiator cross member 23. By distributing the brackets 26 over the width of the vehicle, uniform support is achieved.

FIGS. 9 and 10 show further options for providing the support 11 by combining the radiator grille 10 with a stop 27 formed by the inside 6 of the hood, either in the form of a shaped profile 28 in FIG. 9 or of a fold 29 in FIG. 10.

FIGS. 11 to 13 show an additional element 30 in the form of a hollow profile, which extends over virtually the entire width of the vehicle. The additional element 30 is joined to the radiator cross member 23 by connecting struts 31, which are oriented in the direction of the radiator cross member 23. The additional element 30 and the connecting struts 21 may be made either of metal or plastics and comprise profiles as illustrated in FIG. 13, for example.

Alternatively, the additional element 30 and the connecting struts 31 may be made in one piece as a large-area support element, which is provided with ribbing on the top and or bottom, in order to achieve corresponding stiffening.

In the exemplary embodiment according to FIG. 14, the radiator cross member 23 is extended forwards in such a way as to form the support 11 for the radiator grille 10. In this case, the radiator cross member 23 may be provided with stiffeners, struts or profiling, depending on requirements.

1-11. (canceled)

12. A motor vehicle front part comprising:
a bumper unit, which comprises a bumper crossbar, and
a support, which stiffens the bumper unit upon a pedestrian impact in a region upstream of the bumper crossbar,
wherein the support is arranged above the bumper crossbar.

13. The motor vehicle front part as claimed in claim 12, wherein the support is formed by combining a radiator grille with a stop in order to prevent deflection of the radiator grille contrary to the direction of travel.

14. The motor vehicle front part as claimed in claim 13, wherein the stop is a flange projecting downwards from a hood of the vehicle.

15. The motor vehicle front part as claimed in claim 14, wherein the flange has an additional element projecting downwards from the hood.

16. The motor vehicle front part as claimed in claim 13, wherein the stop is a profile shaped downwards from the inside of a hood of the vehicle.

17. The motor vehicle front part as claimed in claim 13, wherein the stop is a cross strut, which extends over the width of the vehicle.

18. The motor vehicle front part as claimed in claim 17, wherein brackets protrude from the cross strut and are supported on a supporting structure of the motor vehicle front part.

19. The motor vehicle front part as claimed in claim 18, wherein the supporting structure is an anti-collision radar mount, which is connected to a radiator cross member.

20. The motor vehicle front part as claimed in claim 13, wherein the stop is formed by a profiled additional element and connecting struts, and wherein the connecting struts are supported on the radiator cross member.

21. The motor vehicle front part as claimed in claim 20, wherein the profiled additional element and the connecting struts are constructed in one piece as a large-area support element.

22. The motor vehicle front part as claimed in claim 13, wherein the stop means is a radiator cross member extended forwards.
